(19) United States
(12) Patent Application Publication
(10) Pub. No.: US 2011/0153135 A1
(43) Pub. Date: Jun. 23, 2011

(54) TRAVEL CONTROL DEVICE FOR UNMANNED CONVEYANCE VEHICLE

(75) Inventor: Jun Kondo, Aichi-ken (JP)

(73) Assignee: Toyota Shatai Kabushiki Kaisha, Aichi-ken (JP)

(21) Appl. No.: 13/061,141

(22) PCT Filed: Mar. 12, 2010
(86) PCT No.: PCT/JP2010/054180

§ 371 Date: Feb. 26, 2011

(30) Foreign Application Priority Data
Jun. 26, 2009 (JP) 2009-152530

(51) Int. Cl. G05D 1/02

(52) U.S. Cl. 701/23

(57) ABSTRACT

When an unmanned conveyance vehicle travels straight along a main guide tape 12, the rotational speeds of a pair of drive wheels of the unmanned conveyance vehicle are controlled such that the center position O2 of a guide sensor 23 is matched with the center position O1 of the guide tape 12. When the unmanned conveyance vehicle is turned to the right along a branch guide tape 13, a turning operation of the unmanned conveyance vehicle is controlled such that the center position O2 of the guide sensor 23 is matched with an inner side edge 13a of the branch guide tape 13 in the turning direction.

### TECHNICAL FIELD

The present invention relates to a travel control device for an unmanned conveyance vehicle in a production system, more specifically, to a travel control device for an unmanned conveyance vehicle that improves control accuracy in a traveling direction when the unmanned conveyance vehicle is turned along a guide tape at a branch point along a travel route.

### BACKGROUND ART

Conventionally, as a control device for an unmanned conveyance vehicle, a control device disclosed in Patent Document 1 has been proposed. In this control device, an automotive unmanned conveyance vehicle 11 which conveys a load is guided by a guide tape 12 configured by a magnetic tape laid down along a travel route as shown in FIG. 7. A guide sensor 23 which detects the guide tape 12 is installed in the unmanned conveyance vehicle 11. The guide sensor 23 includes an attaching board 24 and a plurality (sixteen) of sensing elements 25 such as Hall elements. The sensing elements 25 are arranged at predetermined pitches along the widthwise direction of a vehicle body on the attaching board 24. The guide tape 12 is always detected by some (for example, five) of the sensing elements 25. In order to control the travel direction of the automotive unmanned conveyance vehicle 11, weighting indexes from 1 to 16 are set for the sixteen sensing elements 25 of the guide sensor 23 which detects the guide tape 12 on a road travel surface, respectively. By using the total sum of the weighting indexes of some of the sensing elements 25 that are ON, the center position O2 (the center position O1 of the guide tape 12) of the ON sensing elements 25 is obtained. Depending on the deviation Δd, which is the distance between the center position O3 of the unmanned conveyance vehicle 11 and the center position O1 of the guide tape 12, the deceleration rate of one of the right and left drive wheels (not shown) is set to decelerate the corresponding wheel. In this manner, the travel direction of the unmanned conveyance vehicle 11 is corrected such that the deviation Δd becomes 0, so that the unmanned conveyance vehicle 11 automatically travels along the guide tape 12.

When the course of the unmanned conveyance vehicle 11 is changed by a branch guide tape 13 on the road travel surface, the unmanned conveyance vehicle 11 cannot be easily and properly turned even though the center position O2 of the sensing elements 25 facing the guide tape 12 is simply calculated. In other words, as shown on an upper side in FIG. 7, when the guide sensor 23 of the unmanned conveyance vehicle 11 moves to a position corresponding to the main guide tape 12 and the branch guide tape 13, the guide sensor 23 reacts with a guide tape having a width W2 larger than the width W1 of the main guide tape 12. This results in an increase of the number of sensing elements 25 that are turned on by the main guide tape 12 and the branch guide tape 13. For this reason, the center position of the ON sensing elements 25 changes from O2 to O4, and the center position of the guide tape also changes from the center position O1 of the guide tape 12 to a center position O6 of the branch guide tape 13. The unmanned conveyance vehicle 11 is guided to adjust the center position O3 to the center position O6 of the guide tape. In other words, as shown by a line formed by a long dash alternating with two short dashes in FIG. 7, the unmanned conveyance vehicle 11 is guided along a track T displaced to the left from the center position O5 of the branch guide tape 13. More specifically, the unmanned conveyance vehicle 11 is guided along a track having a large turning radius. In this manner, the unmanned conveyance vehicle 11 cannot be easily and properly turned.

In order to solve the above problem, Patent Document 1 takes the following countermeasure. More specifically, when the unmanned conveyance vehicle 11 is turned to the right, positions of the sensing elements 25 located on a right edge 13a of the branch guide tape 13 are obtained. A predetermined number is added to or subtracted from the positions of the sensing elements 25 to calculate the center position O3 of the unmanned conveyance vehicle 11. A turning operation is controlled such that the center position O3 of the unmanned conveyance vehicle 11 is matched with the center position O5 of the branch guide tape 13 to make it possible to properly turn the unmanned conveyance vehicle 11 to the right. In this manner, when the unmanned conveyance vehicle 11 is turned to the right, the right edge 13a of the branch guide tape 13 is used as a reference for controlling the position of the unmanned conveyance vehicle 11.

In the conventional method for controlling, however, it is necessary to calculate the position of the sensing element 25 located closest to the turning-direction side, and to add or subtract a predetermined number to/from the position of the sensing element 25 so as to calculate the center position O3 of the unmanned conveyance vehicle 11 (guide sensor 23). Performing such a complex calculation renders cumbersome a turning operation program to turn the unmanned conveyance vehicle 11. It is also necessary to frequently perform the arithmetic operation for calculating the center position O3 of the unmanned conveyance vehicle 11 (guide sensor 23) so as to sensitively adjust the position of the unmanned conveyance vehicle 11. Therefore, the turning operation of the unmanned conveyance vehicle 11 cannot be smoothly performed. In order to prevent the unmanned conveyance vehicle 11 from over sensitively reacting, the traveling direction may be controlled only when the deviation between the center position O5 of the branch guide tape 13 and the center position O3 of the unmanned conveyance vehicle 11 exceeds a tolerance level. However, such a control program is very difficult to be applied as the turning control program with a complex arithmetic operation.

### PRIOR ART DOCUMENT

### Patent Document

Patent Document 1: Japanese Laid-Open Patent Publication No. 8-44427

### SUMMARY OF THE INVENTION

### Problem to be Solved by the Invention

Accordingly, it is an objective of the present invention to provide a travel control device for an unmanned conveyance vehicle that can easily create an operation program for use in turning control and smoothly perform a turning operation of the unmanned conveyance vehicle.

### Means for Solving the Problem

In order to achieve the foregoing objective and in accordance with a first aspect of the present invention, a travel control device for an unmanned conveyance vehicle is provided. The travel control device includes a guide sensor and a control unit. The guide sensor detects main guide means and branch guide means, which are laid down along a road travel surface. The guide sensor is configured by a plurality of sensing elements arranged at predetermined intervals in a direction intersecting a traveling direction of the unmanned conveyance vehicle. The control unit calculates a deviation between a center position of a guide sensor and a center position of a predetermined number of sensing elements that are turned on by the main guide means, and controls travel of the unmanned conveyance vehicle on the basis of the deviation such that the center position of the guide sensor is matched with the center position of the main guide means. The control unit performs control such that the center position of the guide sensor is matched with an inner side edge of the branch guide means in a turning direction when the unmanned conveyance vehicle travels through a branch.

According to the configuration, when the unmanned conveyance vehicle travels on a branch road, the control unit performs control such that the center position of the guide sensor is matched with the inner side edge of the branch guide means in the turning direction. This eliminates the need for a complex arithmetic operation, thereby allowing an operation program for turning control to easily be formed. It is possible to easily integrate, in a turning control program serving as a reference, a control program for preventing a travel direction of the unmanned conveyance vehicle from being over sensitively adjusted, that is, a control program for preventing a travel direction of the unmanned conveyance vehicle from being adjusted when the deviation between a side edge of the branch guide means and the center position of the guide sensor falls within a tolerance level. For this reason, a turning operation of the unmanned conveyance vehicle can be smoothly performed.

In the travel control device for an unmanned conveyance vehicle, the control unit preferably includes offset amount canceling means for canceling an offset amount of the unmanned conveyance vehicle toward the inner side in a turning direction when the unmanned conveyance vehicle travels through a branch.

In the travel control device for an unmanned conveyance vehicle, the offset amount canceling means preferably performs control such that the center position of the guide sensor is matched with the center position of the branch guide means by changing the effective ones of the sensing elements configuring the guide sensor into sensing elements located in a direction in which the offset amount is canceled.

In the travel control device for an unmanned conveyance vehicle, the guide means are preferably configured by magnetic tapes, and the sensing elements are preferably configured by Hall elements.

In the travel control device for an unmanned conveyance vehicle, a marker that instructs the unmanned conveyance vehicle to turn is preferably provided on the road travel surface, a marker sensor for detecting the marker is preferably provided in the unmanned conveyance vehicle, and the control unit preferably performs control such that the center position of the guide sensor is matched with a side edge of the branch guide means after the marker is detected by the marker sensor.

### BRIEF DESCRIPTION OF THE DRAWINGS

FIG. 1 is a plan view for explanatory illustration of a travel control operation of an unmanned conveyance vehicle according to the present invention when the unmanned conveyance vehicle travels in a straight line and turns.

FIG. 2 is a plan view showing an unmanned conveyance vehicle according to one embodiment of the present invention.

FIG. 3 is a right side view of the unmanned conveyance vehicle.

FIG. 4 is a block circuit diagram of a control system that controls a travel operation of the unmanned conveyance vehicle.

FIG. 5 is a plan view for explanatory illustration of a turning operation of the unmanned conveyance vehicle to the right.

FIG. 6 is a plan view for explanatory illustration of a travel control operation for an unmanned conveyance vehicle according to another embodiment of the present invention.

FIG. 7 is a plan view for explanatory illustration of a travel control operation for a conventional unmanned conveyance vehicle when the unmanned conveyance vehicle travels in a straight line and turns.

### MODE FOR CARRYING OUT THE INVENTION

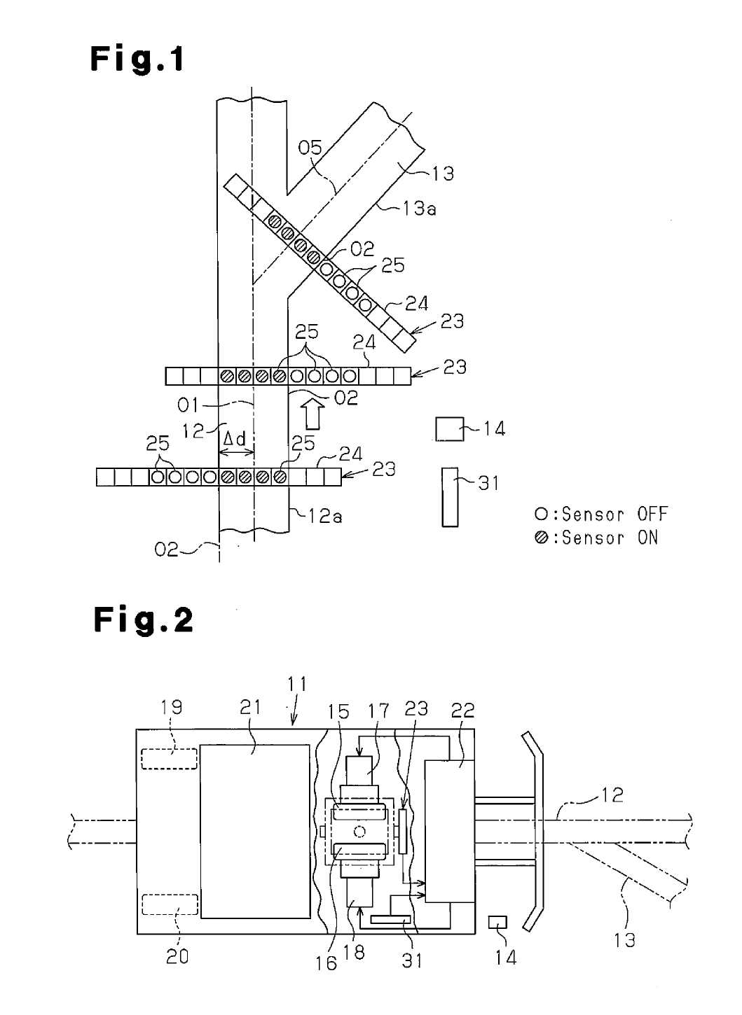

A travel control device for an unmanned conveyance vehicle according to one embodiment of the present invention will now be described with reference to FIGS. 1 to 5.

As shown in FIG. 2, an unmanned conveyance vehicle 11 is used for automatic conveyance or the like of machine parts and travels along a travel route set in advance in a factory. A main guide tape 12 serving as main guide means configured by a magnetic tape is laid down along the travel route. A branch guide tape 13 serving as branch guide means configured by a magnetic tape obliquely intersecting the main guide tape 12 is also laid down along the travel route. Each of the main guide tape 12 and the branch guide tape 13 has a predetermined width (for example, 5 cm). Along the travel route, a plurality of magnetic markers 14 configured by magnetic tapes are laid down. The magnetic markers 14 give instructions for a stop, a course change, a speed change, or other various pieces of control information to the unmanned conveyance vehicle 11. The magnetic markers 14 are located on a side of the main guide tape 12 and the branch guide tape 13.

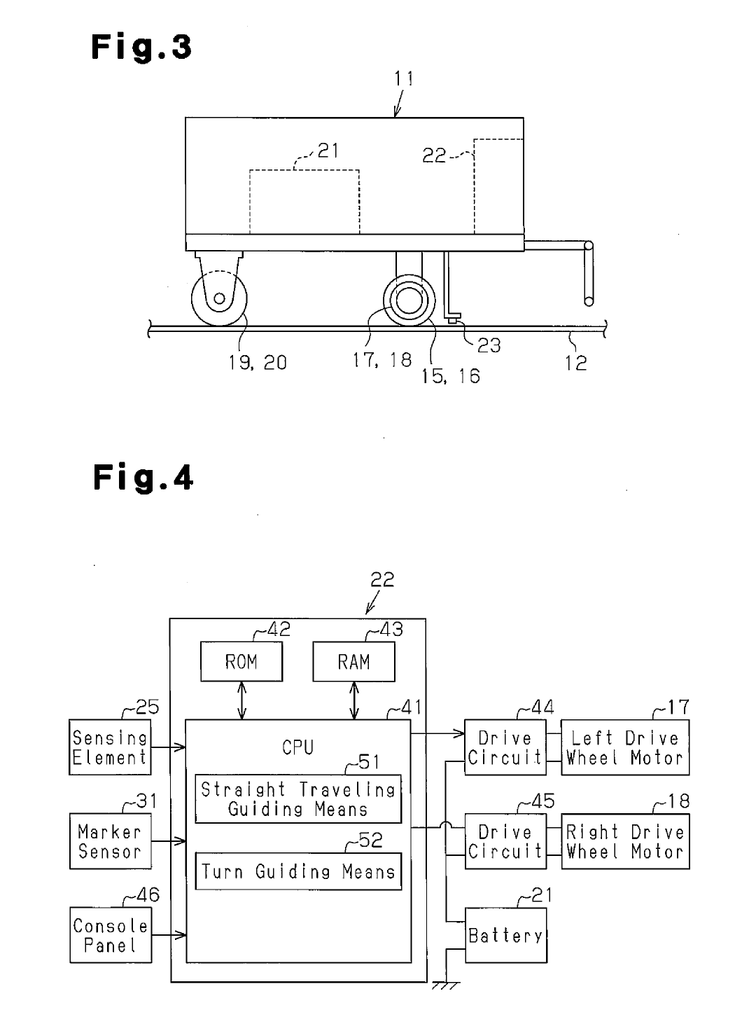

As shown in FIGS. 2 and 3, a pair of left and right front wheels 15 and 16 are provided on a lower part of the vehicle body of the unmanned conveyance vehicle 11. The front wheels 15 and 16 are rotationally driven by electric motors 17 and 18, respectively. A pair of left and right driven wheels 19 and 20 are provided on a lower part of the vehicle body. The driven wheels 19 and 20 are arranged at the rear of the front wheels 15 and 16, respectively. The vehicle body houses therein a battery 21 serving as driving energy and a control unit 22 that controls various operations of the unmanned conveyance vehicle 11.

A guide sensor 23 for detecting the position of the guide tape 12 (13) is provided on a front part of the unmanned conveyance vehicle 11. As shown in FIG. 1, the guide sensor 23 includes a belt-like attaching board 24 oriented in the widthwise direction of the unmanned conveyance vehicle 11 and sensing elements 25 configured by a plurality (for example, 14) of Hall elements or the like. The attaching board 24 is made of a nonmagnetic material such as a synthetic resin. The sensing elements 25 are arranged at predetermined intervals along the widthwise direction of the unmanned conveyance vehicle 11, i.e., directions intersecting a travel direction of the unmanned conveyance vehicle 11 on the attaching board 24. Some (for example, four) of the sensing elements 25 are arranged to face the guide tape 12 (13). When some of the sensing elements 25 are turned on, detection signals are output from the ON sensing elements 25 to the control unit 22.

As shown in FIG. 2, a marker sensor 31 to detect the magnetic marker 14 is arranged on the front part of the unmanned conveyance vehicle 11. The marker sensor 31 is configured by a sensing element configured by a Hall element or the like. A detection signal (ON signal, OFF signal, and control information) detected by the marker sensor 31 is transmitted to the control unit 22.

The configuration and the functions of the control unit 22 will be described below with reference to FIG. 4.

As shown in FIG. 4, the control unit 22 includes a central processing unit (CPU) 41 that performs various arithmetic operations and determining operations on the basis of various data. Connected to the CPU 41 are a read-only memory (ROM) 42 from which data is only read and a random access memory (RAM) 43 in and from which various data can be written and read. Data such as a program to drive and control the unmanned conveyance vehicle 11 is stored in the read-only memory (ROM) 42 in advance. The electric motor 17 is connected to the CPU 41 via a drive circuit 44 operated by the battery 21. The electric motor 18 is connected to the CPU 41 via a drive circuit 45. The detection signals detected by the sensing elements 25 and the marker sensor 31 are input to the CPU 41. A console panel 46 having a keyboard to input various data is connected to the CPU 41.

The CPU 41 includes a guide control means 51. The guide control means 51 controls the electric motors 17 and 18 on the basis of the detection signals transmitted from the sensing elements 25. In this manner, the unmanned conveyance vehicle 11 can travel along the guide tape 12. In the guide control means 51, a function to detect the position of the guide tape 12 is given to the several (eight) sensing elements 25 located at an intermediate part of the total of fourteen sensing elements 25 (see FIG. 1). The sensing elements 25 expressed by three squares on each of the left and right sides of the guide sensor 23 are not used to detect the guide tape 12 while the unmanned conveyance vehicle 11 runs along the guide tape 12.

The CPU 41 includes turn guiding means 52 which outputs various control signals when the unmanned conveyance vehicle 11 is turned. As shown in FIG. 1, for example, when the unmanned conveyance vehicle 11 is to be turned to the right, the turn guiding means 52 turns the unmanned conveyance vehicle 11 to the right in a state in which a center position O2 (center position of the unmanned conveyance vehicle 11) of the effective sensing elements 25 used to detect the guide tape 12 is matched with the right edges 12a and 13a of the guide tape 12 and the branch guide tape 13. Therefore, as shown in FIG. 1, the unmanned conveyance vehicle 11 is turned such that the center position of the unmanned conveyance vehicle 11, i.e., the center position O2 of the guide sensor 23 is offset by one half the width of the branch guide tape 13.

An operation of the unmanned conveyance vehicle 11 will be described below.

As shown in FIG. 1, while the unmanned conveyance vehicle 11 travels along the guide tape 12, the detection signals detected by the eight effective sensing elements 25 of the total number of fourteen sensing elements 25 are transmitted to the guide control means 51 of the CPU 41, so that traveling of the unmanned conveyance vehicle 11 is controlled. More specifically, weighting indexes of 1 to 8 are set to the eight sensing elements 25, respectively, thereby obtaining the total sum of the weighting indexes of the ON sensing elements 25 of the eight sensing elements 25. By using the total sum, the center position of the ON sensing elements 25, i.e., the center position O1 of the guide tape 12 is calculated. Subsequently, calculation is made of the deviation Δd between the center position O1 of the guide tape 12 and the center position O2 of the unmanned conveyance vehicle 11. On the basis of the calculated deviation Δd, a deceleration rate of one of the front wheels 15 and 16 is set to decelerate the corresponding wheel. In this manner, the travel direction of the unmanned conveyance vehicle 11 is corrected such that the deviation Δd becomes zero, thereby controlling automatic traveling of the unmanned conveyance vehicle 11.

As shown in FIG. 2, the unmanned conveyance vehicle 11 comes close to the magnetic marker 14 on the front part of the branch guide tape 13. When the magnetic marker 14 is detected by the marker sensor 31, control information (right turn) of the magnetic marker 14 is transmitted to the CPU 41 of the control unit 22. As shown in FIG. 1, the unmanned conveyance vehicle 11 turns to the right on the basis of the control signal from the control unit 22.

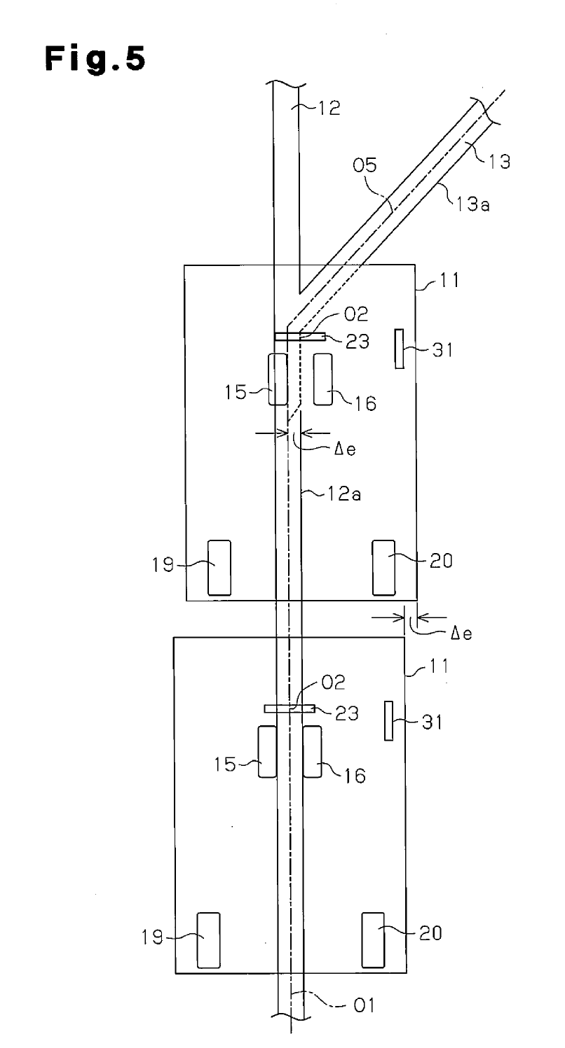

When a right turn of the unmanned conveyance vehicle 11 is started, the turn guiding means 52 controls the unmanned conveyance vehicle 11 as described below (see FIG. 4). That is, as shown in FIG. 1, the travel direction of the unmanned conveyance vehicle 11 is controlled such that the center position O2 of the unmanned conveyance vehicle 11 (the center position O2 of the guide sensor 23) is matched with the right edge 12a. As shown in FIGS. 1 and 5, the center position O2 of the unmanned conveyance vehicle 11 is offset from the center position O1 of the guide tape 12 to the right by a distance Δe, which is one half the width of the guide tape 12. In this state, the unmanned conveyance vehicle 11 turns to the right along the right edges 12a and 13a of the guide tape 12 and branch guide tape 13.

According to the travel control device for the unmanned conveyance vehicle 11, the following advantages are achieved.

(1) When the unmanned conveyance vehicle 11 turns to the left or right, the center position O2 of the unmanned conveyance vehicle 11 (the guide sensor 23) is matched with one of the left or right side edge 12a of the guide tape 12, not with the center position O1 of the guide tape 12. In this state, the unmanned conveyance vehicle 11 is turned along the inner side edge of the branch guide tape 13 in the turn direction, i.e., along the right or left side edge 13a of the branch guide tape 13. In this manner, the turn radius of the unmanned conveyance vehicle 11 becomes small, and a turning operation of the unmanned conveyance vehicle 11 can be smoothly performed.

(2) The control is as simple as matching the center position O2 of the unmanned conveyance vehicle 11 (guide sensor 23) with the inner side edges 12a and 13a of the guide tape 12 and the branch guide tape 13 in the turning direction. This allows an operation program for turning and controlling the unmanned conveyance vehicle 11 to be easily formed. It is also possible to easily integrate, in the turning control program serving as a reference, a control program to prevent the traveling direction of the unmanned conveyance vehicle 11 from being over sensitively adjusted, i.e., a control program to prevent the traveling direction of the unmanned conveyance vehicle 11 from being performed when the deviation between the side edge 13a of the branch guide tape 13 and the center position O2 of the guide sensor 23 falls within a tolerance level.

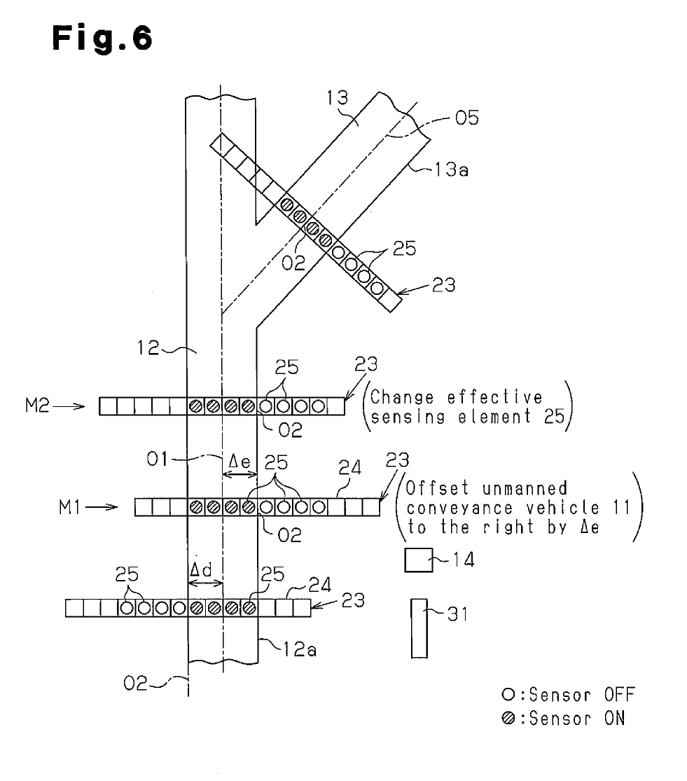

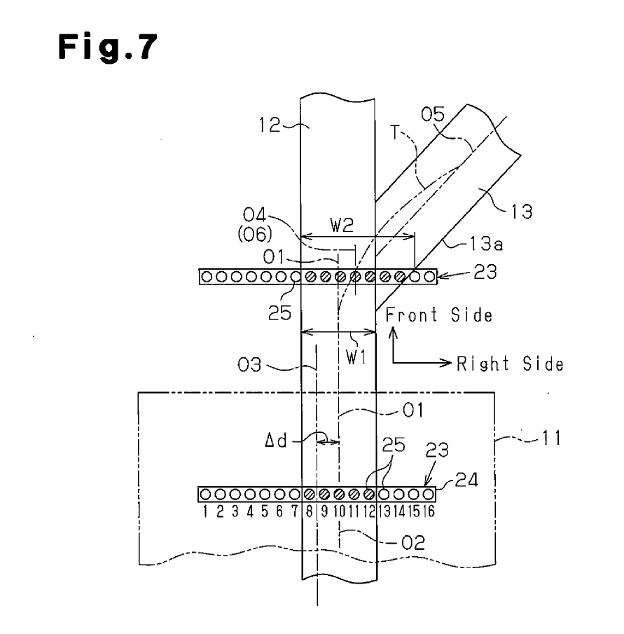

Another embodiment of the present invention will be described below with reference to FIG. 6. Since the present embodiment is different from the embodiment described above concerning only the function of the CPU 41 of the control unit 22 shown in FIG. 4, an explanation of the configuration will be omitted.

In the present embodiment, the CPU 41 of the control unit 22 shown in FIG. 4 includes offset amount canceling means (not shown) for matching the center position O2 of the unmanned conveyance vehicle 11 (guide sensor 23) with the center position O5 of the branch guide tape 13. The following operation is performed by the offset amount canceling means. More specifically, as shown in FIG. 6, the center position O2 of the unmanned conveyance vehicle 11 (the guide sensor 23) is set to the right side edge 12a of the guide tape 12. As shown in FIG. 5, the entire unmanned conveyance vehicle 11 is offset to the right by the distance Δe (see M1 in FIG. 6). In this case, as indicated by M2 in FIG. 6, the eight effective sensing elements 25 for detecting the main guide tape 12 of the sensing elements 25 of the guide sensor 23 are shifted to sensing elements located in a direction to cancel the distance Δe (offset amount). This control enables the center position O2 of the guide sensor 23 to be matched with the center position O5 of the branch guide tape 13, and the offset amount (distance Δe) of the unmanned conveyance vehicle 11 to be canceled, as shown on the uppermost side in FIG. 6. Therefore, the unmanned conveyance vehicle 11 can turn along the branch guide tape 13 without being offset.

The embodiment may be modified as follows.

The number of sensing elements 25 of the guide sensor 23 need not be fourteen and may be an arbitrary number, for example, fifteen or more.

For example, guide means such as a reflecting tape or a plurality of copper electric wires may be used in place of the guide tapes 12 and 13. In such cases, corresponding other sensing elements are used in place of the sensing elements 25 configured by Hall elements of the guide sensor 23.

### DESCRIPTION OF REFERENCE NUMERALS

Δd . . . Deviation (offset amount), O1, O2, O5 . . . Center positions, 11 . . . Unmanned conveyance vehicle, 12 . . . Main guide tape serving as main guide means, 13 . . . Branch guide tape serving as branch guide means, 22 . . . Control unit, 23 . . . Guide sensor, 25 . . . Sensing element, 31 . . . Marker sensor.

1. A travel control device for an unmanned conveyance vehicle, the travel control device comprising:
a guide sensor for detecting main guide means and branch guide means that are laid down on a road travel surface, the guide sensor being configured by a plurality of sensing elements arranged at predetermined intervals in a direction intersecting a travel direction of the unmanned conveyance vehicle; and
a control unit that calculates a deviation between a center position of the guide sensor and a center position of a predetermined number of sensing elements that are turned on by the main guide means, and controls travel of the unmanned conveyance vehicle on the basis of the deviation such that the center position of the guide sensor is matched with the center position of the main guide means,
wherein the control unit performs control for matching the center position of the guide sensor with an inner side edge of the branch guide means in a turning direction when the unmanned conveyance vehicle travels through a branch.

2. The travel control device for an unmanned conveyance vehicle according to claim 1, wherein the control unit includes offset amount canceling means for canceling an offset amount of the unmanned conveyance vehicle to an inner side in a turning direction when the unmanned conveyance vehicle travels through a branch.

3. The travel control device for an unmanned conveyance vehicle according to claim 2, wherein the offset amount canceling means shifts effective ones of the sensing elements configuring the guide sensor to sensing elements located in a direction to cancel the offset amount, thereby performing control for matching the center position of the guide sensor with the center position of the branch guide means.

4. The travel control device for an unmanned conveyance vehicle according to claim 1, wherein the guide means are configured by magnetic tape, and the sensing elements are configured by Hall elements.

5. The travel control device for an unmanned conveyance vehicle according to claim 1, wherein a marker that instructs the unmanned conveyance vehicle to turn is provided on the road travel surface, a marker sensor for detecting the marker is provided on the unmanned conveyance vehicle, and the control unit performs control for matching the center position of the guide sensor with a side edge of the branch guide means after the marker is detected by the marker sensor.
